(19) United States
(12) Patent Application Publication
(10) Pub. No.: US 2024/0342525 A1
(43) Pub. Date: Oct. 17, 2024

(54) METHODS AND APPARATUS FOR FIRE EXTINGUISHING AGENT DEPLOYMENT

(71) Applicant: General Electric Company, Schenectady, NY (US)

(72) Inventors: Kevin Edward Hinderliter, Loveland, OH (US); Arthur W Sibbach, Boxford, MA (US)

(21) Appl. No.: 18/300,240

(22) Filed: Apr. 13, 2023

(51) Int. Cl. A62C 3/08; A62C 99/00

(52) U.S. Cl. CPC A62C 3/08; A62C 99/0018

(57) ABSTRACT

Methods and apparatus for dual-purposing of thermal transport bus (TTB) working fluid as a fire extinguishing agent are disclosed herein. An example fire extinguishing system includes a thermal transport bus to transfer heat between fluids on an aircraft using a working fluid, and a fire extinguishing nozzle connected to the thermal transport bus, the fire extinguishing nozzle positioned to deploy the working fluid as a fire extinguishing agent to a location of the aircraft.

### FIELD OF THE DISCLOSURE

This disclosure relates generally to aircraft-based fire extinguishing system, and, more particularly, to a fire extinguishing system to deploy a working fluid as a fire extinguishing agent to an aircraft.

### BACKGROUND

Aircraft onboard systems are designed to include fire extinguishing installations to extinguish fires that occur during flight or while the aircraft is stationed on the ground. Fire extinguishing installations on aircraft can include portable extinguishers installed at specific locations (e.g., in the main cabin, on the flight deck) and hold fire extinguishing systems (e.g., based on automatic fire detection).

### BRIEF DESCRIPTION OF THE DRAWINGS

FIG. 1 is a side view of an example aircraft.

FIG. 2 is a schematic diagram of an example thermal management system to transfer heat between fluids.

FIG. 3 is a schematic diagram of an example fire extinguishing system implemented in a thermal transport bus associated with the thermal management system of FIG. 2.

FIG. 4 is a block diagram of an example fire extinguishing controller circuitry that may be incorporated into a thermal transport bus-based fire extinguishing system developed in accordance with teachings of this disclosure.

FIG. 5 is a flowchart representative of example machine readable instructions that may be executed by example processor circuitry to implement the fire extinguishing controller circuitry of FIG. 4.

FIG. 6 is a block diagram of an example processing platform including processor circuitry structured to execute the example machine readable instructions and/or the example operations of FIG. 5 to implement the fire extinguishing controller circuitry of FIG. 4.

In general, the same reference numbers will be used throughout the drawing(s) and accompanying written description to refer to the same or like parts. The figures are not substantially to scale.

### DETAILED DESCRIPTION

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this application, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an clement in the detailed description, while the same element may be referred to in a claim with a different descriptor such as “second” or “third.” In such instances, it should be understood that such descriptors are used merely for identifying those elements distinctly that might, for example, otherwise share a same name.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a ten percent margin.

The terms “forward” and “aft” refer to relative positions within a gas turbine engine, pump, or vehicle, and refer to the normal operational attitude of the gas turbine engine, pump, or vehicle. For example, with regard to a gas turbine engine, forward refers to a position closer to an engine inlet and aft refers to a position closer to an engine nozzle or exhaust. Further, with regard to a pump, forward refers to a position closer to a pump inlet and aft refers to a position closer to an end of the pump opposite the inlet.

The terms “upstream” and “downstream” refer to the relative direction with respect to a flow in a pathway. For example, with respect to a fluid flow, “upstream” refers to the direction from which the fluid flows, and “downstream” refers to the direction to which the fluid flows.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmed with instructions to perform specific operations and including one or more semiconductor-based logic devices (e.g., electrical hardware implemented by one or more transistors). Examples of processor circuitry include programmed microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of the processing circuitry is/are best suited to execute the computing task(s).

A turbine engine, also referred to herein as a gas turbine engine, is a type of internal combustion engine that uses atmospheric air as a moving fluid. The gas turbine engine is a turbofan engine that includes a fan section upstream of a low-pressure compressor section and a bypass airflow passage. During operation, a volume of air enters an inlet of the engine and passes into the fan section. A first portion of air is directed or routed into the bypass airflow passage, and a second portion of air is directed or routed into the low-pressure compressor section where the pressure of the air is increased. The pressure of the second portion of air is further increased as it is routed through a high-pressure compressor section and into a combustion chamber where the pressurized air is mixed with fuel and burned to provide combustion gases. Subsequently, the combustion gases are routed through a high- pressure turbine section and a low-pressure turbine section, where a portion of thermal and/or kinetic energy from the combustion gases is extracted.

The combustion gases are then routed through a jet exhaust nozzle section of the gas turbine engine to provide propulsive thrust. Simultaneously, the pressure of the first portion of air is substantially increased as the first portion of air is routed through the bypass airflow passage before it is exhausted from a fan nozzle exhaust section of the turbofan engine, also providing propulsive thrust. The combination of propulsive thrusts from the first and second portions of air determines an overall thrust that the turbofan engine generates to propel the aircraft in flight. In this sense, the power of the gas turbine engine can be defined as a product of the overall thrust and the cruising speed of the aircraft.

Pumps (e.g., centrifugal pumps/compressors, axial pumps/compressors, etc.) are utilized in thermal management systems (TMSs) to pressurize (drive) a working fluid (e.g., water, oil, supercritical carbon dioxide (sCO2), liquid helium, helium-xenon, etc.) through a thermal transport bus loop. Such TMSs can heat or cool accessory systems, sections, and/or components in the engine(s) to improve the power, efficiency, and/or structural integrity thereof. The TMS includes the thermal transport bus (TTB) to transmit the working fluid (or heat exchange fluid) between elements (e.g., accessory systems, sections, components, etc.) of the gas turbine engine such that heat can be transferred to/from the working fluid and from/to the elements.

In some examples, the TMS uses sCO2 as the working fluid because it has a low viscosity and a high specific heat, enabling heat sources (e.g., heat exchangers) to efficiently transfer heat to and/or from the sCO2. Additionally, sCO2 is chemically stable, reliable, readily available, and non-flammable, making sCO2 more advantageous than some other heat exchange fluids (e.g., water, air, etc.). Furthermore, although sCO2 can change to a gaseous phase, this does not present challenges associated with other heat exchange fluids that can freeze (e.g., water). The TMS includes a TTB pump (or sCO2 pump) to pressurize the sCO2 within the TTB. The TTB pump may be a centrifugal pump or an axial pump (e.g., a single-stage centrifugal pump, a multistage centrifugal pump, a multistage axial pump, etc.) that uses an electric motor to rotate a shaft coupled to one or more rotors (e.g., impellers, rotor blades, etc.), which draws the working fluid into a pump inlet and accelerates the working fluid radially and/or axially to the pump outlet and/or other rotors in the pump.

In accordance with Federal Aviation Administration (FAA) requirements, aircraft must be equipped with fire extinguishers and/or fire extinguishing agents. For example, fire extinguishers and/or fire extinguishing agents can be used to mitigate the occurrence of potential fires within the aircraft cabin or the flight deck, as well as in any other region of the aircraft. Fires can involve energized electrical equipment, ordinary combustibles (e.g., rubber, cloth, etc. present in cabin furnishings), and/or other flammable substances (e.g., oils, gases, etc.). In some examples, water glycol-based fire extinguishers can be used on solid material fires whereas carbon dioxide-based fire extinguishers can be used on liquid and/or electrical equipment fires.

In addition to hand-held fire extinguishers, hold fire extinguishing systems can be activated in the presence of abnormal heat detection in an aircraft hold. Fire suppression capability associated with hold fire extinguishing systems includes instant deployment of an extinguishing agent, with more gradual deployment of a remaining portion of the agent over a prolonged period of time (e.g., up to an hour) to prevent re-ignition and/or partial fire suppression. Potential fire extinguishing agents can include hydrofluorocompounds (HFCs), water misting, inert gas (e.g., nitrogen) and/or dry powder. In particular, halogenated hydrocarbons (e.g., Halons) are a fire extinguishing agent used for engine fire protection, as well as cargo and/or dry bay fire protection. For example, Halon 1301 has been used as a total flooding agent, while Halon 1211 has been used as a streaming agent. However, the production of Halon has been restricted and replacement agents are being actively pursued.

Carbon dioxide (CO2) is an effective extinguishing agent. CO2-based fire extinguishers are used for engine-based fires, as well as for fires originating from flammable fluids and/or electrical equipment. CO2 is non-combustible and easily liquified by compressed and cooling, remaining in a closed container as both a liquid and a gas, the liquid expanding to a gas during discharging into the atmosphere. Absorption of heat by CO2 gas during vaporization cools the remaining liquid, resulting in solid dry ice particles that act as a blanketing agent. Likewise, CO2 can replace air above a burning surface given that CO2 is heavier than air, creating a smothering atmosphere. As such, systems and methods for supporting the application of CO2 as a fire extinguishing agent throughout an aircraft would be welcomed in the field.

Examples disclosed herein introduce the use of the thermal transport bus (TTB) technology of the thermal management system (TMS) as a support system for fire extinguishing on an aircraft. For example, fire extinguishing valves can be integrated into the TTB architecture to vent the working fluid (e.g., CO2) as a fire extinguishing agent. In particular, the TTB-based fire extinguishing system can be used to release the working fluid (e.g., CO2) in designated locations and/or at designated times based on abnormal heat detection. In examples disclosed herein, dual purposing the TTB as a fire extinguishing plumbing network and fire extinguishing agent reservoir reduces the total required external system volume and/or weight needed for supporting the fire extinguishing system.

Widespread deployment of the TTB network across propulsion systems in combination with the fire extinguishing system proposed herein would introduce an effective method of storing and deploying a fire extinguishing agent that can be used throughout an aircraft. In examples disclosed herein, existing TTB temperature sensors can be dual purposed for identification of zone(s) and/or associated nozzle(s) for activation of the fire extinguishing system. Furthermore, the fire extinguishing system presented herein can be used to support FAA requirements of sequential discharges from separate sources (e.g., one after the other) to completely extinguish a fire if a first source of the fire extinguishing agent is not adequate for extinguishing the fire (e.g., lowering the level of abnormal heat detected by the temperature sensors). In examples disclosed herein, the use of CO2 as a working fluid in the TTB system can be used for fire suppression in various areas of an aircraft (e.g., cargo, engine, etc.). While in examples disclosed here CO2 is the primary working fluid described in connection with the TTB system, any other applicable type and/or combination of working fluid(s) that can serve the purpose of a fire extinguishing agent can be implemented.

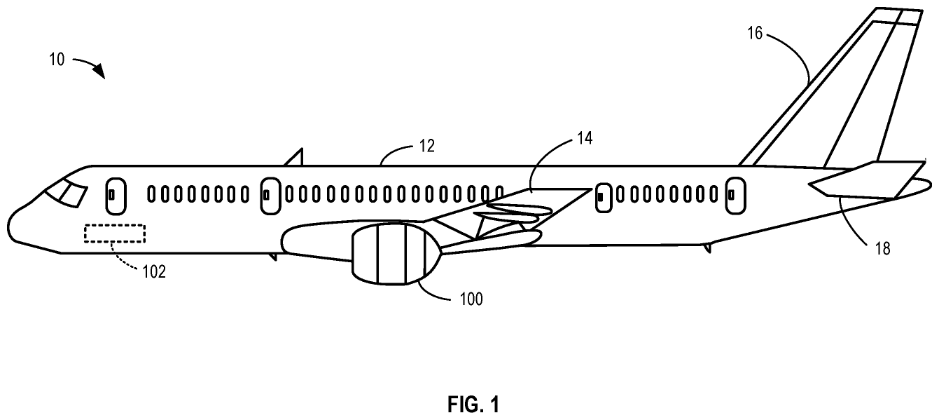

For the figures disclosed herein, identical numerals indicate the same elements throughout the figures. Referring now to the drawings, FIG. 1 is a side view of an example aircraft 10. As shown in FIG. 1, the aircraft 10 includes a fuselage 12 and a pair of wings 14 (one is shown) extending outward from the fuselage 12. In the illustrated example, a gas turbine engine 100 is supported on each wing 14 to propel the aircraft through the air during flight. Additionally, the aircraft 10 includes a vertical stabilizer 16 and a pair of horizontal stabilizers 18 (one is shown). However, in some examples, the aircraft 10 includes engines of different types and/or in different positions than the illustrative example of FIG. 1.

Furthermore, the aircraft 10 includes a thermal management system 102 (TMS 102) for transferring heat between fluids supporting the operation of the aircraft 10. More specifically, the aircraft 10 includes one or more accessory systems to support the operation of the aircraft 10. For example, such accessory systems include a lubrication system that lubricates components of the engines 100, a cooling system that provides cooling air to components of the engines 100, an environmental control system that provides cooled air to the cabin of the aircraft 10, and/or the like. In such examples, the TMS 102 is arranged to transfer heat from one or more fluids supporting the operation of the aircraft 10 (e.g., the oil of the lubrication system, the air of the cooling system and/or the environmental control system, and/or the like) to one or more other fluids supporting the operation of the aircraft 10 (e.g., the fuel supplied to the engines 100). However, in some other examples, the TMS 102 is arranged to transfer heat directly to and/or from other components that support the operation of the aircraft 10 without an intermediate fluid.

Although examples disclosed herein are described with reference to the aircraft 10 of FIG. 1, examples disclosed herein can be applicable to another type or configuration of aircraft that uses a thermal management system similar to the TMS 102 of FIGS. 1-3. Thus, the present subject matter can be readily adaptable to another aircraft (e.g., military jet aircraft, cargo aircraft, etc.) with another engine (e.g., turbojet, turboprop, etc.). Furthermore, although the TMS 102 of FIG. 1 is shown as located in the fuselage 12 of the aircraft 10, the TMS 102 (or a portion of the TMS 102, such as the TTB, a heat exchanger, the TTB pump, etc.) can be located within the wing 14, the engine 100, and/or another location in the aircraft 10.

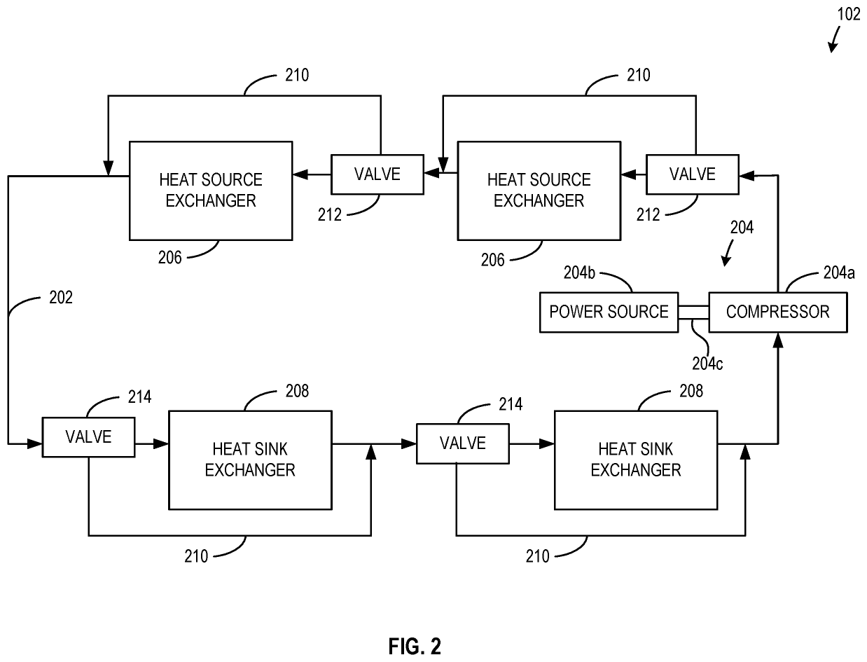

FIG. 2 is a schematic diagram of an example implementation of the TMS 102 for transferring heat between fluids. In general, the TMS 102 is discussed in the context of the aircraft 10 described above and shown in FIG. 1. However, the TMS 102 can be implemented within another type of aircraft and/or another gas turbine engine of another configuration.

As shown, the TMS 102 includes a thermal transport bus 202 to transmit a working fluid (e.g., a heat exchange fluid) throughout the TMS 102. Specifically, the thermal transport bus 202 (TTB 202) includes one or more fluid conduits through which the working fluid flows. As described below, the working fluid flows through various heat sinks (e.g., heat exchangers) such that heat is added to and/or removed from the working fluid. In the illustrated example, the working fluid can be supercritical carbon dioxide (sCO2). Furthermore, the TMS 102 includes a thermal transport bus pump 204 (TTB pump 204) to pump the working fluid through the TTB 202.

The TTB pump 204 of the TMS 102 includes a compressor 204a and a power source 204b coupled to a shaft 204c. The compressor 204a is rotatably interlocked with the shaft 204c, and the power source 204b drives rotation of the shaft 204c. Thus, the power source 204b drives rotation of the compressor 204a, and the rotation of the compressor 204a provides a pressure head to the working fluid in the TTB 202 downstream of the TTB pump 204. When the compressor 204a increases the pressure of the working fluid, the flow rate of the working fluid accelerates downstream toward a low pressure end (e.g., upstream of the TTB pump 204). Thus, the TTB pump 204 drives the working fluid through the TMS 102.

In some examples, the compressor 204a is a centrifugal compressor or pump (or radial compressor) and includes one or more impellers. Thus, the working fluid can enter along an axis of rotation of the compressor 204a and accelerate radially outward from the rotating impeller into an outlet port, which creates the increased pressure head. In some examples, the compressor 204a is a single-stage centrifugal compressor having a single impeller mounted on an end of the shaft 204c. In some examples, the compressor 204a is a multistage centrifugal compressor having multiple impellers mounted in series along on the shaft 204c. In some examples, the compressor 204a is an axial compressor having multiple stages of rotors and stators that sequentially increase the pressure of the working fluid. Thus, the working fluid can enter along the axis of rotation of the compressor 204a and pressurize/accelerate along a flow path parallel to the axis of rotation. In some examples, the compressor 204a is a rotary screw compressor including two adjacent shafts with spiral threads that mesh together. As the working fluid radially enters the rotary screw compressor, the two shafts rotate and force the fluid axially along the shafts. The fluid pressure increases as the rotating threads drive the flow into an outlet where the working fluid radially exits from the rotary screw compressor. In some examples, the compressor 204a is a fixed displacement style of compressor (e.g., piston, scroll, gear, etc.). For example, a volume of CO2 enters a chamber with a reciprocating geometry continually cycling the compression and expansion of the CO2 volume. During the compression stroke, a captured, relatively low-pressure gas is reduced in volume, correspondingly increasing the gas pressure. At the end of the compression process, the higher-pressure gas is ejected from the compressor and fed to the downstream TTB component(s).

The power source 204b generates torque from electrical and/or mechanical power and transfers that torque along the shaft 204c to the compressor 204a. In some examples, the power source 204b is an electric motor (e.g., direct current (DC) brushless motor, etc.) including fields magnets that emit magnetic fields and an armature (or armature windings) that generate alternating electromagnetic fields. Either the stator or the rotor can be configured as the armature based on the type of example motor implemented as the power source 204b. In such examples, the electric motor includes a rotor and a stator, and the rotor is coupled to the shaft 204c, which rotates based on magnetic interactions between the field magnets and the armature.

In some examples, the power source 204b is a turbine that extracts thermal energy of the working fluid in the TTB 202 to generate mechanical power. Such a configuration includes multiple sequential stages of rotating rotor blades and stationary stator blades that generate mechanical power based on the kinetic and thermal energies of the working fluid. In some examples, the TTB pump 204 includes a separate motor coupled to the shaft 204c in conjunction with the power source 204b (e.g., turbine) to supplement the power available to the compressor 204a. In some examples, the power source 204b is configured in another manner to provide power to the compressor 204a that corresponds with a certain pressure output of the TTB pump 204.

The TMS 102 includes one or more heat source exchangers 206 arranged along the thermal transport bus 202. More specifically, the heat source exchangers 206 are fluidly coupled to the thermal transport bus 202 such that the working fluid flows through the heat source exchangers 206. In some examples, the heat source exchangers 206 transfer heat from fluids supporting the operation of the aircraft 10 to the working fluid, which cools the fluids supporting the operation of the aircraft 10 and heats the working fluid.

The heat source exchangers 206 can correspond to heat exchangers for cooling a fluid to support the operation of the aircraft 10. In some examples, at least one of the heat source exchangers 206 is coupled to a lubrication system of the engine 100. Thus, the heat source exchanger 206 can transfer heat from the oil lubricating the engine 100 to the working fluid. In some examples, at least one of the heat source exchangers 206 is coupled to a cooling system of the engine 100. Thus, the heat source exchanger 206 can transfer heat from the cooling air bled from a compressor section of the engine 100 to the working fluid. In some examples, the heat source exchangers 206 correspond to another manner of cooling a fluid supporting the operation of the aircraft 10.

Furthermore, the TMS 102 includes a plurality of heat sink exchangers 208 arranged along the thermal transport bus 202. More specifically, the heat sink exchangers 208 are fluidly coupled to the thermal transport bus 202 such that the working fluid flows through the heat sink exchangers 208. In some examples, the heat sink exchangers 208 transfer heat from the working fluid to other fluids supporting the operation of the aircraft 10, which heats the other fluids supporting the operation of the aircraft 10 and cools the working fluid.

The heat sink exchangers 208 can correspond to heat exchangers for heating a fluid to support the operation of the aircraft 10. In some examples, at least of one of the heat sink exchangers 208 is coupled to a fuel system of the engine 100. Thus, the heat sink exchanger 208 can transfer heat from the working fluid to the fuel flowing through a fuel supply flowline of the engine 100 of FIG. 1.

The TMS 102 of FIG. 2 includes one or more bypass conduits 210 to allow the working fluid to circumvent the heat source exchangers 206 or the heat sink exchangers 208. As shown, each of the bypass conduits 210 is fluidly coupled to the thermal transport bus 202 such that at least a portion of the working fluid can bypass the heat source exchangers 206 or the heat sink exchangers 208. Furthermore, the TMS 102 includes one or more heat source valves 212 to cause a portion of the working fluid to enter the bypass conduits 210 and circumvent one or more of the heat source exchangers 206. The TMS 102 also includes one or more heat sink valves 214 to cause a portion of the working fluid to enter the bypass conduits 210 and circumvent one or more of the heat sink exchangers 208. The heat source valves 212 and the heat sink valves 214 are fluidly coupled to the thermal transport bus 202 and the corresponding bypass conduits 210.

As shown in FIG. 2, each heat source exchanger 206 and each heat sink exchanger 208 has a corresponding bypass conduit 210. In some examples, other numbers of heat source exchangers 206 and/or heat sink exchangers 208 can have a corresponding bypass conduit 210. In some examples, the heat source valves 212 and the heat sink valves 214 are hydraulically controlled based on the pressure of the working fluid within the thermal transport bus 202. Thus, for example, when the pressure of the heat exchange fluid satisfies a certain pressure threshold, the heat source valve(s) 212 opens to cause a portion of the working fluid to bypass the heat source exchanger(s) 206.

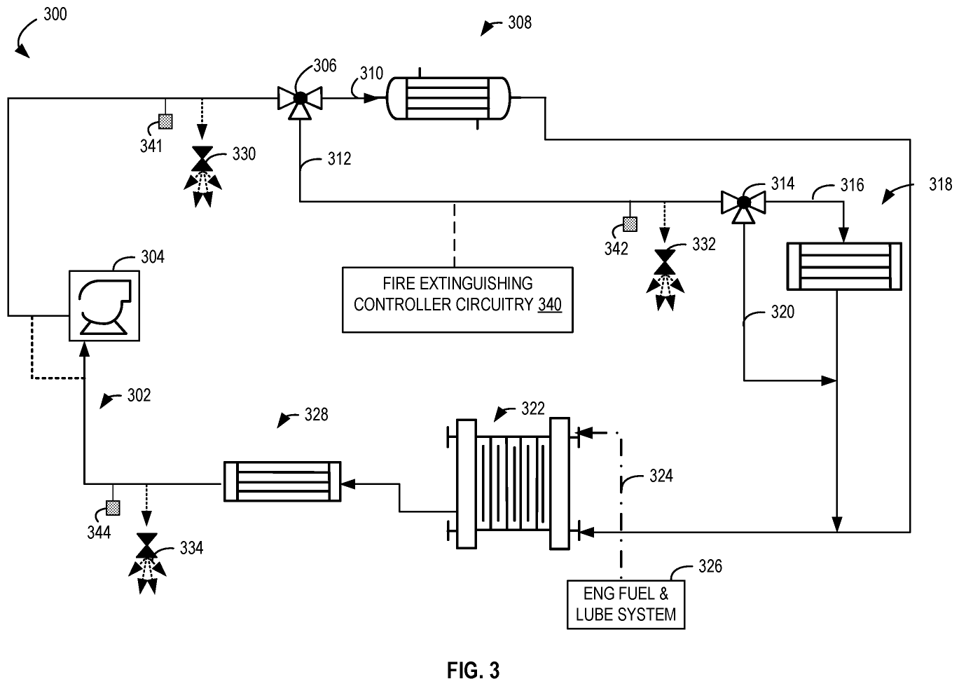

FIG. 3 is a schematic diagram 300 of an example fire extinguishing system implemented in an example thermal transport bus (TTB) 302 associated with the thermal management system (TMS) 102 of FIG. 2. For example, the TMS 102 is generally illustrated to show positioning of heat source(s) (e.g., heat exchangers, heat sinks, etc.) and valve(s) in connection with the TTB 202, while in the example of FIG. 3, a specific example of the TMS is shown with the TTB 302 in connection with a first heat source, a second heat source, etc. In the example of FIG. 3, a supercritical CO2 (sCO2) pump 304 creates a mass flow of the sCO2 through the TTB 302 to pressurize the sCO2 within the TTB 302. The sCO2 pump 304 may be a centrifugal pump or an axial pump (e.g., a single-stage centrifugal pump, a multistage centrifugal pump, a multistage axial pump, etc.) that uses an electric motor to rotate a shaft coupled to one or more rotors (e.g., impellers, rotor blades, etc.), which draws the sCO2 into a pump inlet and accelerates the working fluid radially and/or axially to the pump outlet and/or other rotors in the sCO2 pump 304. The low-temperature, high-pressure sCO2 flow exiting the sCO2 pump 304 travels along the TTB 302 and enters an example first flow split valve 306 that regulates sCO2 through an example first heat source 308.

Once heat source regulation is attained, the sCO2 flow can be directed by the first flow split valve 306 to bypass the first heat source 308 via an example second TTB branch 312. The remaining sCO2 entering the second TTB branch 312 passes to an example second flow split valve 314. A portion of the sCO2 flow from the second flow split valve 314 enters an example third TTB branch 316 and flows towards an example second heat source 318, while another portion of the sCO2 flow from the second flow split valve 314 bypasses the second heat source 318 via an example fourth TTB branch 320. The sCO2 flow diverted through the second heat source 318 elevates the temperature of the sCO2 that is bypassed around the first heat source 308 via the second TTB branch 312. Subsequently, both the sCO2 exiting the second heat source 318 and the remaining sCO2 bypassing the second heat source 320 merges with sCO2 exiting the first heat source 308. For example, both the outlet sCO2 from the second heat source 318 and the sCO2 originating from the first heat source 308 are at the highest temperature state.

The combined sCO2 flow is passed to a heat sink heat exchanger 322, where the high temperature sCO2 flow is cooled. The cooled sCO2 exiting the first heat sink 322 passes to an example second heat sink 328. The second heat sink 328 provides additional cooling needed to meet the heat source regulation needs of the system. The second heat sink 328 also protects the sCO2 pump 304 from receiving too high a temperature of sCO2 that could cause damage to the sCO2 pump 304.

The TTB 302 of FIG. 3 is distributed across the overall propulsion system. Given the use of CO2 as a natural fire extinguishing agent, the sCO2 flow in the TTB 302 can be deployed through example fire extinguishing nozzle(s) 330, 332, 334 distributed throughout the TTB 302 architecture. In the example of FIG. 3, the fire extinguishing nozzle(s) 330, 332, 334 are positioned upstream of the first flow split valve 306 (e.g., nozzle 330), upstream of the second flow split valve 314 (e.g., nozzle 332), and/or downstream of the fourth heat source 328, respectively. In some examples, the fire extinguishing nozzle 330 is positioned upstream of the first flow split valve 306 and downstream of the sCO2 pump 304. In some examples, the fire extinguishing nozzle 332 is positioned upstream of the second flow split valve 314 and downstream of the first heat source 308 and/or the first flow split valve 306. In some examples, the fire extinguishing nozzle 334 is positioned upstream of the sCO2 pump 304 and downstream of the fourth heat source (e.g., fourth heat source 328). In examples disclosed herein, the first heat source, the second heat source, the third heat source, and/or the fourth heat source includes bleed air, bypass streams, exhaust heat, etc. In some examples, the heat source(s) can include electrical component(s) (e.g., a generator, a converter, etc.). In some examples, the heat source(s) can be heat exchangers with an associated fluid. In some examples, the heat source is cooled with the thermal transport bus (TTB) fluid, where the TTB fluid is used for thermal communication. As such, thermal communication can occur among thermal sinks and/or heat source(s).

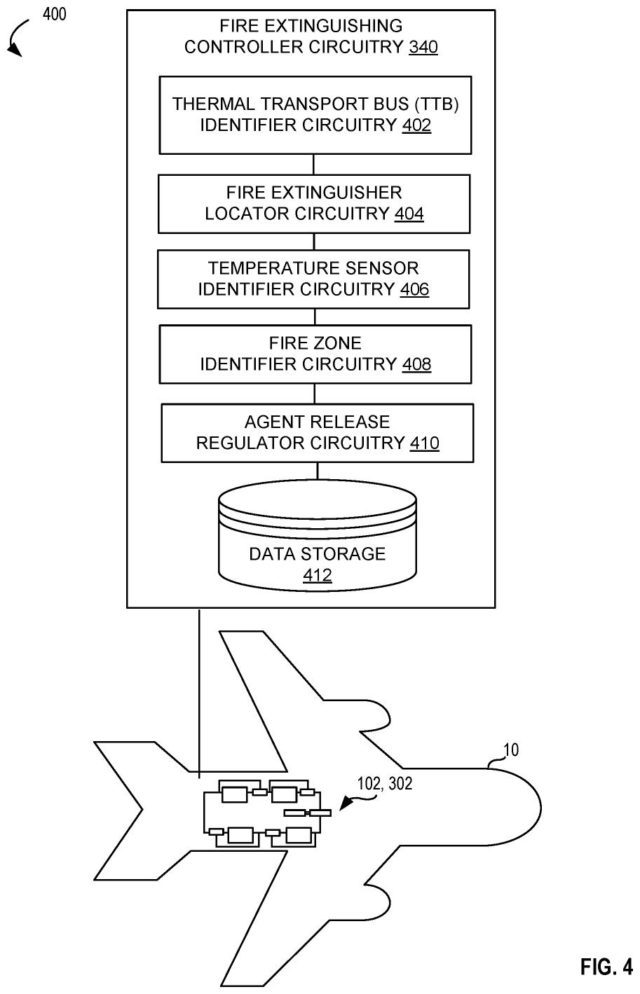

However, the quantity and/or location of the fire extinguishing nozzle(s) 330, 332, 334 can vary depending on the fire extinguishing needs throughout the propulsion system. In the example of FIG. 3, fire extinguishing controller circuitry 340 is used to monitor and/or control the fire extinguishing nozzle(s) 330, 332, 334. In some examples, the fire extinguishing controller circuitry 340 uses temperature sensors to monitor temperature readings in the vicinity of the fire extinguishing nozzle(s) 330, 332, 334. For example, the fire extinguishing controller circuitry 340 detects abnormal levels of heat (e.g., when temperature reading reaches >482 degrees C.), as described in more detail in connection with FIG. 4. For example, the fire extinguishing controller circuitry 340 can receive input(s) from dedicated fire sensor(s) in the core compartment(s) around the engine (e.g., in addition to fire sensor(s) positioned on the TTB 302). The core of the engine includes the high pressure compressor, the combustor and the high pressure turbine. For example, the core compartment refers to the area surrounding these engine modules and is enclosed by an inner portion of a fan bypass duct. In some examples, the low pressure turbine is housed within the core compartment. The fan bypass flow surrounds the core compartment and provides a thermal insulator to components housed in the outer nacelle. In some examples, temperature sensor(s) (e.g., sensor(s) 341, 342, 344) are positioned to monitor the sCO2 temperature within the TTB 302 and/or temperature sensor(s) can be positioned to monitor the temperature of the sCO2 pump 304. In some examples, the fire extinguishing controller circuitry 340 triggers a system shut down and deploys sCO2 via the fire extinguishing nozzle(s) 330, 332, 334 (e.g., when temperature reading reaches >482 degrees C.).

In some examples, the fire extinguishing controller circuitry 340 activates the fire extinguishing nozzle(s) 330, 332, 334 in the zone(s) and/or surrounding areas closest to where the abnormal heat is detected. In some examples, the fire extinguishing nozzle(s) 330, 332, 334 can be positioned in locations where fuel is present (e.g., near fuel flow 324) and/or in the presence of flammable liquids (e.g., oil present in connection with the sCO2 pump 304). In some examples, the fire extinguishing nozzle(s) 330, 332, 334 can be positioned in locations at risk of electrical fires. In some examples, the TTB 302 can be rerouted circuitously to allow for the positioning of the fire extinguishing nozzle(s) 330, 332, 334 in desired locations throughout the propulsion system. In some examples, the fire extinguishing nozzle(s) 330, 332, 334 include, and/or can be replaced with, one or more valve(s) in the TTB 302 in connection with a tube that does not contain sCO2. In some examples, the fire extinguishing controller circuitry 340 controls the valve(s) to allow for a specified quantity of sCO2 to be released from the TTB 302. In some examples, the fire extinguishing controller circuitry 340 controls the duration of sCO2 release from the TTB 302 (e.g., via fire extinguishing nozzle(s) 330, 332, 334).

In some examples, multiple TTBs can be deployed for improved reliability and/or overall thermal transport robustness. In some examples, the fire extinguishing controller circuitry 340 can cause discharging of sCO2 in multiple TTBs based on zones determined to be in need of fire extinguishing agent deployment (e.g., based on temperature sensor readings). In some examples, the fire extinguishing controller circuitry 340 can discharge fire extinguishing agent from multiple TTBs one at a time or simultaneously. In some examples, the fire extinguishing controller circuitry 340 can discharge fire extinguishing agent for a first period of time (e.g., 0<t<x) from a first TTB, followed by discharging of the fire extinguishing agent from a second TTB for a second period of time (e.g., x<t<y), before returning to the use of the first TTB to continue discharging the fire extinguishing agent for a third period of time (e.g., y<t<z). For example, the second TTB can be a sCO2 cooled electrical conductor (e.g., electrical bus). In some examples, the total volume of sCO2 in the TTB 302 can be determined based on existing fire extinguishing requirements and/or fire safety regulations. For example, an accumulator can be added to the TMS to support additional volumes of sCO2. In some examples, additional sources of sCO2 can be used (e.g., in addition to the sCO2 present in the TTB 302) to supplement the total quantity of sCO2 available to support fire extinguishing requirements.

FIG. 4 is a block diagram 400 of an example fire extinguishing controller circuitry 340 that may be incorporated into a thermal transport bus-based fire extinguishing system developed in accordance with teachings of this disclosure. The fire extinguishing controller circuitry 340 of FIG. 4 may be instantiated (e.g., creating an instance of, bring into being for any length of time, materialize, implement, etc.) by processor circuitry such as a central processing unit executing instructions. Additionally or alternatively, the fire extinguishing controller circuitry 340 of FIG. 4 may be instantiated (e.g., creating an instance of, bring into being for any length of time, materialize, implement, etc.) by an ASIC or an FPGA structured to perform operations corresponding to the instructions. It should be understood that some or all of the circuitry of FIG. 4 may, thus, be instantiated at the same or different times. Some or all of the circuitry may be instantiated, for example, in one or more threads executing concurrently on hardware and/or in series on hardware. Moreover, in some examples, some or all of the circuitry of FIG. 4 may be implemented by microprocessor circuitry executing instructions to implement one or more virtual machines and/or containers.

The fire extinguishing controller circuitry 340 includes example thermal transport bus (TTB) identifier circuitry 402, example fire extinguisher locator circuitry 404, example temperature sensor identifier circuitry 406, example fire zone identifier circuitry 408, example agent release regulator circuitry 410, and an example data storage 412. In the example of FIG. 4, the fire extinguishing controller circuitry 340 is in communication with a thermal transport bus (e.g., TTB 302 of FIG. 3) and/or a thermal management system (e.g., TMS 102 of FIG. 2) positioned on an aircraft (e.g., aircraft 10 of FIG. 1).

The TTB identifier circuitry 402 identifies one or more thermal transport bus(es) associated with a thermal management system. In some examples, the TTB identifier circuitry 402 determines the location of the one or more TTBs (e.g., TTB 302) on an aircraft (e.g., aircraft 10). For example, the TTB identifier circuitry 402 can identify TTB(s) located in various areas of the aircraft (e.g., in the fuselage 12, within the wing 14, the engine 100, and/or another location in the aircraft 10 of FIG. 1). In some examples, the TTB identifier circuitry 402 identifies TTBs that are specifically constructed to provide fire extinguishing capability (e.g., include fire extinguishing nozzle(s) for release of a fire extinguishing agent).

The fire extinguisher locator circuitry 404 identifies one or more fire extinguishing capabilities associated with the TTBs identified and/or located by the TTB identifier circuitry 402. For example, the fire extinguisher locator circuitry 404 identifies fire extinguishing nozzle(s) 330, 332, 334 (FIG. 3) that are positioned throughout the identified TTB. In some examples, the fire extinguisher locator circuitry 404 identifies valve(s) associated with release of a fire extinguishing agent (e.g., valve(s) used for controlling release of sCO2 from the TTB). For example, release of the fire extinguishing agent can be performed using any type of release mechanism, not confined to nozzle(s) and/or valves.

The temperature sensor identifier circuitry 406 identifies temperature sensor(s) used for monitoring temperature(s) on the TTB. In some examples, the temperature sensor identifier circuitry 406 identifies temperature sensor(s) positioned on the TTB and/or in connection with fire extinguishing nozzle(s) and/or valves. In some examples, the temperature sensor identifier circuitry 406 identifies and/or receives input(s) from dedicated fire sensor(s) in the core compartments around the engine (e.g., in addition to fire sensor(s) positioned on the TTB 302). In some examples, the temperature sensor identifier circuitry 406 uses the temperature sensor(s) to monitor the sCO2 temperature within the TTB 302 and/or the temperature of the sCO2 pump 304 (FIG. 3). In some examples, the fire extinguishing controller circuitry 340 (FIG. 3) uses the temperature sensor identifier circuitry 406 to monitor for abnormal temperatures indicative of a fire (e.g., >482 degrees C.) based on input(s) from the identified temperature sensor(s).

The fire zone identifier circuitry 408 identifies a zone(s) of an aircraft where abnormal heat can be mitigated using dedicated fire extinguishing nozzle(s) and/or valves. For example, fire extinguishing nozzle(s) 330, 332, 334 (FIG. 3) can be spread out on a given TTB to allow for fire extinguishing agent to be released in specific zone(s) and/or surrounding areas closest to where the abnormal heat is detected. For example, fire extinguishing nozzle(s) 330, 332, 334 can be positioned in locations where fuel is present (e.g., near fuel flow 324 of FIG. 3), in the presence of flammable liquids (e.g., oil present in connection with the sCO2 pump 304 (FIG. 3), and/or in locations at risk of electrical fires. As such, the fire zone identifier circuitry 408 identifies zone(s) on the aircraft where fire extinguishing agent can be released from the TTB based on the positioning of the TTB. The fire extinguishing controller circuitry 340 (FIG. 3) can identify the fire extinguishing nozzle(s) and/or valves to activate when abnormal temperature readings are recorded based on the zone(s) in which the abnormal temperatures occur.

The agent release regulator circuitry 410 releases fire extinguishing agent (e.g., sCO2) from the TTB when abnormal temperature(s) are detected using dedicated temperature sensor(s). The agent release regulator circuitry 410 controls the amount of sCO2 that is released from the fire extinguishing nozzle(s) 330, 332, 334 (FIG. 3). In some examples, the agent release regulator circuitry 410 can initiate discharge(s) from fire extinguishing nozzle(s) 330, 332, 334 on one or more TTBs according to the zone(s) and/or locations of the recorded abnormal temperature(s). In some examples, the agent release regulator circuitry 410 determines the order of activation and/or amount of fire extinguishing agent release from the fire extinguishing nozzle(s) 330, 332, 334. In some examples, the agent release regulator circuitry 410 controls sequential discharges from separate sources of fire extinguishing agent (e.g., sCO2) to completely extinguish a fire if a first source of the fire extinguishing agent is not adequate for extinguishing the fire. In some examples, the agent release regulator circuitry 410 simultaneously activates all fire extinguishing nozzle(s) 330, 332, 334. In some examples, the agent release regulator circuitry 410 activates the fire extinguishing nozzle(s) 330, 332, 334 in sequence. In some examples, the agent release regulator circuitry 410 activates and/or reactivates a particular fire extinguishing nozzle depending on a volume of agent needed to extinguish the fire (e.g., lower temperature readings from abnormal levels back to normal levels).

The data storage 412 can be used to store any information associated with the TTB identifier circuitry 402, the fire extinguisher locator circuitry 404, the temperature sensor identifier circuitry 406, the fire zone identifier circuitry 408, and/or the agent release regulator circuitry 410. The example data storage 412 of the illustrated example of FIG. 4 can be implemented by any memory, storage device and/or storage disc for storing data such as flash memory, magnetic media, optical media, etc. Furthermore, the data stored in the example data storage 412 can be in any data format such as binary data, comma delimited data, tab delimited data, structured query language (SQL) structures, image data, etc.

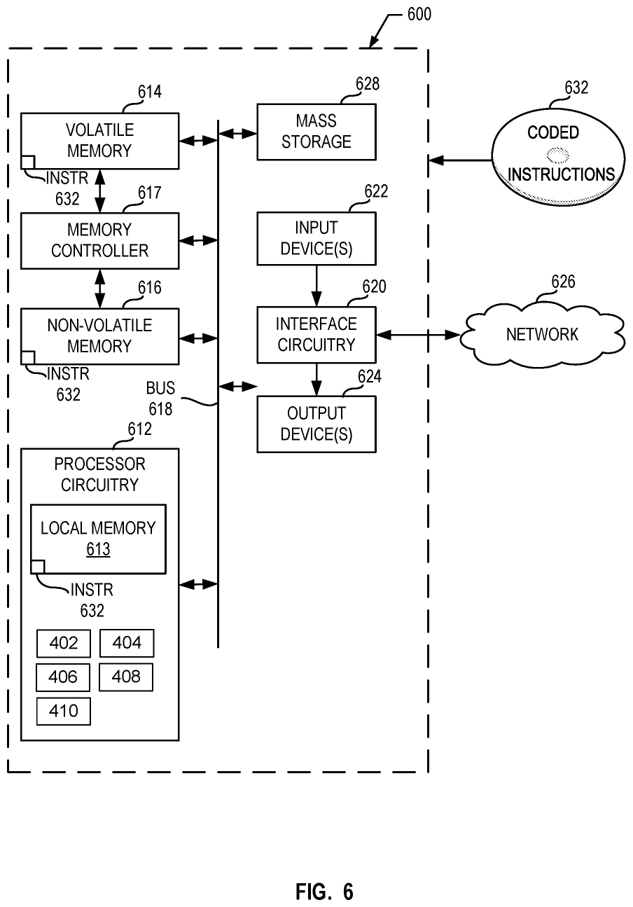

In some examples, the apparatus includes means for identifying a thermal transport bus. For example, the means for identifying a thermal transport bus may be implemented by TTB identifier circuitry 402. In some examples, the TTB identifier circuitry 402 may be instantiated by processor circuitry such as the example processor circuitry 612 of FIG. 6. Additionally or alternatively, the TTB circuitry 402 may be instantiated by any other combination of hardware, software, and/or firmware. For example, the TTB circuitry 402 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the apparatus includes means for locating a fire extinguisher. For example, the means for locating a fire extinguisher may be implemented by fire extinguisher locator circuitry 404. In some examples, the fire extinguisher locator circuitry 404 may be instantiated by processor circuitry such as the example processor circuitry 612 of FIG. 6. Additionally or alternatively, the fire extinguisher locator circuitry 404 may be instantiated by any other combination of hardware, software, and/or firmware. For example, the fire extinguisher locator circuitry 404 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the apparatus includes means for identifying a temperature sensor. For example, the means for identifying a temperature sensor may be implemented by temperature sensor identifier circuitry 406. In some examples, the temperature sensor identifier circuitry 406 may be instantiated by processor circuitry such as the example processor circuitry 612 of FIG. 6. Additionally or alternatively, the temperature sensor identifier circuitry 406 may be instantiated by any other combination of hardware, software, and/or firmware. For example, the temperature sensor identifier circuitry 406 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the apparatus includes means for identifying a fire zone. For example, the means for identifying a fire zone may be implemented by fire zone identifier circuitry 408. In some examples, the fire zone identifier circuitry 408 may be instantiated by processor circuitry such as the example processor circuitry 612 of FIG. 6. Additionally or alternatively, the fire zone identifier circuitry 408 may be instantiated by any other combination of hardware, software, and/or firmware. For example, the fire zone identifier circuitry 408 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the apparatus includes means for regulating agent release. For example, the means for regulating agent release may be implemented by agent release regulator circuitry 410. In some examples, the agent release regulator circuitry 410 may be instantiated by processor circuitry such as the example processor circuitry 612 of FIG. 6. Additionally or alternatively, the agent release regulator circuitry 410 may be instantiated by any other combination of hardware, software, and/or firmware. For example, the agent release regulator circuitry 410 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

While an example implementation of the fire extinguishing controller circuitry 340 of FIG. 3 is illustrated in FIG. 4, one or more of the elements, processes, and/or devices illustrated in FIG. 4 may be combined, divided, re-arranged, omitted, eliminated, and/or implemented in any other way. Further, the TTB identifier circuitry 402, the fire extinguisher locator circuitry 404, the temperature sensor identifier circuitry 406, the fire zone identifier circuitry 408, the agent release regulator circuitry 410, and/or, more generally, the fire extinguishing controller circuitry 340 of FIGS. 3 and/or 4, may be implemented by hardware, software, firmware, and/or any combination of hardware, software, and/or firmware. Thus, for example, any of the TTB identifier circuitry 402, the fire extinguisher locator circuitry 404, the temperature sensor identifier circuitry 406, the fire zone identifier circuitry 408, the agent release regulator circuitry 410, and/or, more generally, the fire extinguishing controller circuitry 340 of FIG. 3, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example fire extinguishing controller circuitry 340 of FIG. 3 may include one or more elements, processes, and/or devices in addition to, or instead of, those illustrated in FIG. 4, and/or may include more than one of any or all of the illustrated elements, processes and devices.

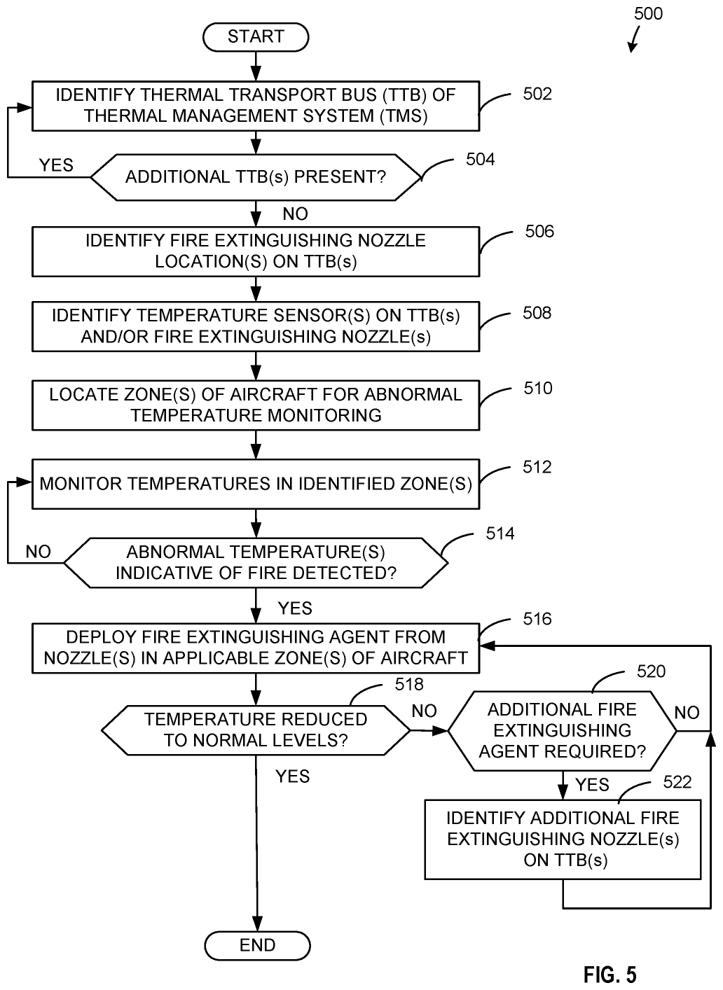

A flowchart representative of example hardware logic circuitry, machine readable instructions, hardware implemented state machines, and/or any combination thereof for implementing the fire extinguishing controller circuitry 340 of FIG. 4 is shown in FIG. 5. The machine readable instructions may be one or more executable programs or portion(s) of an executable program for execution by processor circuitry, such as the processor circuitry 612 shown in the example processor platform 600 discussed below in connection with FIG. 6. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program(s) are described with reference to the flowchart illustrated in FIG. 5, many other methods of implementing the example the fire extinguishing controller circuitry 340 of FIG. 3 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU, an XPU, etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C #, Perl, Python, JavaScript, HyperText Markup Language (HTML), Structured Query Language (SQL), Swift, etc.

As mentioned above, the example operations of FIG. 5 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium, non- transitory computer readable storage medium, non-transitory machine readable medium, and non-transitory machine readable storage medium are expressly defined to include any type of computer readable storage device and/or storage disk and to exclude propagating signals and to exclude transmission media. As used herein, the terms “computer readable storage device” and “machine readable storage device” are defined to include any physical (mechanical and/or electrical) structure to store information, but to exclude propagating signals and to exclude transmission media. Examples of computer readable storage devices and machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer readable instructions, machine readable instructions, etc.

FIG. 5 is a flowchart representative of example machine-readable instructions and/or operations 500 which may be executed and/or instantiated by processor circuitry to implement the example fire extinguishing controller circuitry 340 of FIG. 4 to implement the example fire extinguishing controller circuitry 340 of FIG. 3. The machine readable instructions and/or the operations 500 of FIG. 5 begin at block 502, at which the TTB identifier circuitry 402 identifies one or more TTBs (e.g., TTB 302) associated with a thermal management system (TMS). For example, multiple TTBs can be used throughout an aircraft. In some examples, the TTBs can be positioned in areas such as a fuselage, within an aircraft wing, and/or in any other location of the aircraft. For example, at block 504, the TTB identifier circuitry 402 identifies the presence of additional TTBs on the aircraft. Based on the identified TTB(s), at block 506, the fire extinguisher locator circuitry 404 identifies fire extinguishing nozzle location(s) on the TTB(s). In some examples, the fire extinguisher locator circuitry 404 identifies valve(s) present on the TTB that can be used for fire extinguishing agent deployment. For example, the fire extinguisher locator circuitry 404 identifies fire extinguishing nozzle(s) 330, 332, 334. As such, the fire extinguishing controller circuitry 340 determines the total number of nozzle(s) and/or valves throughout one or more TTB(s) that can be deployed in response to identification of abnormal temperatures.

At block 508, the temperature sensor identifier circuitry 406 identifies temperature sensor(s) on the TTB(s) and/or fire extinguishing nozzle(s). For example, the temperature sensor identifier circuitry 406 identifies temperature sensor(s) that are positioned to determine changes in temperature that are indicative of a fire (e.g., abnormal temperature readings). In some examples, the temperature sensor(s) are positioned in the vicinity of, and/or directly in connection with, the fire extinguishing nozzle(s) 330, 332, 334. At block 510, the fire zone identifier circuitry 408 locates zone(s) of the aircraft for abnormal temperature monitoring. For example, the zone(s) can be associated with areas of the aircraft with fuel and/or flammable substances (e.g., oils, gases, etc.) and include the engine area and/or the cargo area of the aircraft. At block 512, the fire zone identifier circuitry 408 monitors the identified zone(s) of the aircraft using the temperature sensor(s) (e.g., on the TTB). In some examples, the temperature(s) can be monitored on specific areas of the TTB (e.g., such as at the sCO2 pump 304). In some examples, the temperature sensor identifier circuitry 406 receives input(s) from the temperature sensor(s). If, at block 514, the temperature sensor identifier circuitry 406 receives input(s) indicating abnormal temperature reading(s), then, at block 516, the agent release regulator circuitry 410 deploys fire extinguishing agent from nozzle(s) in applicable zone(s) of the aircraft corresponding to the locations where the abnormal temperature readings are taken. In some examples, the agent release regulator circuitry 410 determines the amount of fire extinguishing agent (e.g., sCO2) to release from the fire extinguishing nozzle(s) 330, 332, 334.

At block 518, the temperature sensor identifier circuitry 406 continues to monitor the temperature sensor input(s) to determine whether temperature level(s) are reduced to normal. If the temperature is considered higher than normal, the agent release regulator circuitry 410 continues to deploy sCO2 from the TTB using the fire extinguishing nozzle(s) 330, 332, 334 and/or valve(s). At block 520, the agent release regulator circuitry 410 determines whether additional fire extinguishing agent release is needed. For example, the agent release regulator circuitry 410 can evaluate the rate of temperature reduction based on temperature sensor input(s). If the agent release regulator circuitry 410 determines that additional sCO2 release is needed, the agent release regulator circuitry 410 can change the rate and/or quantity of sCO2 deployment from the fire extinguishing nozzle(s) 330, 332, 334. Additionally, at block 522, the agent release regulator circuitry 410 can identify additional fire extinguishing nozzle(s) on other TTBs in the vicinity and/or zone where temperature reduction is needed. Control returns to block 516 to allow the agent release regulator circuitry 410 to continue fire extinguishing agent release until temperatures are stabilized, as determined at block 518 using temperature sensor-based input(s). In some examples, the agent release regulator circuitry 410 regulates the pressure at which the fire extinguishing agent is released from the TTBs.

FIG. 6 is a block diagram of an example processing platform 600 structured to execute and/or instantiate the machine readable instructions and/or operations of FIG. 5 to implement the example fire extinguishing controller circuitry 340 of FIG. 3. The processor platform 600 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 600 of the illustrated example includes processor circuitry 612. The processor circuitry 612 of the illustrated example is hardware. For example, the processor circuitry 612 can be implemented by one or more integrated circuits, logic circuits, FPGAs microprocessors, CPUs, GPUs, DSPs, and/or microcontrollers from any desired family or manufacturer. The processor circuitry 612 may be implemented by one or more semiconductor based (e.g., silicon based) devices. In this example, the processor circuitry 612 implements the TTB identifier circuitry 402, the fire extinguisher locator circuitry 404, the temperature sensor identifier circuitry 406, the fire zone identifier circuitry 408, and the agent release regulator circuitry 410.

The processor circuitry 612 of the illustrated example includes a local memory 613 (e.g., a cache, registers, etc.). The processor circuitry 612 of the illustrated example is in communication with a main memory including a volatile memory 614 and a non-volatile memory 616 by a bus 618. The volatile memory 614 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 616 may be implemented by flash memory and/or any other desired type of memory device. Access to the main memory 614, 616 of the illustrated example is controlled by a memory controller 617.

The processor platform 600 of the illustrated example also includes interface circuitry 620. The interface circuitry 620 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCle) interface.

In the illustrated example, one or more input devices 622 are connected to the interface circuitry 620. The input device(s) 622 permit(s) a user to enter data and/or commands into the processor circuitry 612. The input device(s) 622 can be implemented by, for example, an audio sensor, a microphone, a camera (still or video), a keyboard, a button, a mouse, a touchscreen, a track-pad, a trackball, an isopoint device, and/or a voice recognition system.

One or more output devices 624 are also connected to the interface circuitry 620 of the illustrated example. The output devices 624 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 620 of the illustrated example, thus, typically includes a graphics driver card, a graphics driver chip, and/or graphics processor circuitry such as a GPU.

The interface circuitry 620 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 626. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 600 of the illustrated example also includes one or more mass storage devices 628 to store software and/or data. Examples of such mass storage devices 628 include magnetic storage devices, optical storage devices, floppy disk drives, HDDs, CDs, Blu-ray disk drives, redundant array of independent disks (RAID) systems, solid state storage devices such as flash memory devices, and DVD drives.

The machine executable instructions 632, which may be implemented by the machine readable instructions of FIG. 5, may be stored in the mass storage device 628, in the volatile memory 614, in the non-volatile memory 616, and/or on a removable non-transitory computer readable storage medium such as a CD or DVD.

From the foregoing, it will be appreciated that example systems, methods, apparatus, and articles of manufacture have been disclosed that permit dual-purposing of thermal transport bus (TTB) working fluid as a fire extinguishing agent. In examples disclosed herein, fire extinguishing valves and/or nozzles can be integrated into the TTB architecture to vent the working fluid (e.g., sCO2) as a fire extinguishing agent. For example, the TTB-based fire extinguishing system can be used to release the working fluid (e.g., sCO2) in designated locations and/or at designated times based on abnormal heat detection. Widespread deployment of the TTB network across a propulsion system in combination with the fire extinguishing system disclosed herein introduces an effective method of storage and deployment of a fire extinguishing agent that can be used throughout an aircraft.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

Example methods and apparatus for dual-purposing of thermal transport bus (TTB) working fluid as a fire extinguishing agent are disclosed herein. Further aspects of the present disclosure are provided by the subject matter of the following clauses.:

A fire extinguishing system, comprising a thermal transport bus to transfer heat between fluids on an aircraft using a working fluid, and a fire extinguishing nozzle connected to the thermal transport bus, the fire extinguishing nozzle positioned to deploy the working fluid as a fire extinguishing agent to a location of the aircraft.

The fire extinguishing system of any preceding clause, wherein the fire extinguishing agent is supercritical carbon dioxide.

The fire extinguishing system of any preceding clause, wherein the thermal transport bus is in connection with at least one of a supercritical carbon dioxide pump or a heat source.

The fire extinguishing system of any preceding clause, wherein the heat source includes at least one of bleed air, a bypass stream, or exhaust heat.

The fire extinguishing system of any preceding clause, wherein the fire extinguishing nozzle is positioned at least one of (1) upstream or downstream of a split valve, or (2) upstream or downstream of a heat source.

The fire extinguishing system of any preceding clause, wherein the thermal transport bus is in connection with a first flow split valve and a second flow split valve, a first fire extinguishing nozzle positioned upstream or downstream of the first flow split valve and a second fire extinguishing nozzle positioned upstream or downstream of the second flow split valve.

An apparatus comprising memory, instructions, and processor circuitry to execute the instructions to obtain a temperature sensor reading from a temperature sensor positioned on a thermal transport bus, the thermal transport bus in connection with a fire extinguishing nozzle, compare the temperature sensor reading to a set temperature range indicative of a fire, and deploy, in response to the temperature sensor reading at or above the set temperature range, fire extinguishing agent from the fire extinguishing nozzle, the fire extinguishing nozzle positioned to deploy the fire extinguishing agent to a location of an aircraft.

The apparatus of any preceding clause, wherein the fire extinguishing agent is supercritical carbon dioxide.

The apparatus of any preceding clause, wherein the thermal transport bus is in connection with a supercritical carbon dioxide pump and a heat source.

The apparatus of any preceding clause, wherein the processor circuitry is to locate an additional thermal transport bus with a fire extinguisher to increase an output of the fire extinguishing agent or increase an area of fire extinguishing agent dispersal.

The apparatus of any preceding clause, wherein the processor circuitry is to regulate at least one of a quantity or a release duration of the fire extinguishing agent exiting the fire extinguishing nozzle during deployment of the fire extinguishing agent from the thermal transport bus.

The apparatus of any preceding clause, wherein the processor circuitry is to identify an additional thermal transport bus in connection with one or more fire extinguishing nozzles, the processor circuitry to initiate fire extinguishing agent release from the one or more fire extinguishing nozzles in response to the temperature sensor continuing to output temperature readings indicative of a fire.

The apparatus of any preceding clause, wherein the fire extinguishing nozzle is positioned upstream or downstream of a supercritical carbon dioxide pump.

A method, comprising obtaining a temperature sensor reading from a temperature sensor positioned on a thermal transport bus, the thermal transport bus in connection with a fire extinguishing nozzle, comparing the temperature sensor reading to a set temperature range indicative of a fire, and deploying, in response to the temperature sensor reading at or above the set temperature range, fire extinguishing agent from the fire extinguishing nozzle, the fire extinguishing nozzle positioned to deploy the fire extinguishing agent to a location of an aircraft.

The method of any preceding clause, wherein the fire extinguishing agent is supercritical carbon dioxide.

The method of any preceding clause, wherein the thermal transport bus is in connection with a supercritical carbon dioxide pump and a heat source.

The method of any preceding clause, further including locating an additional thermal transport bus with a fire extinguisher to increase an output of the fire extinguishing agent or increase an area of fire extinguishing agent dispersal.

The method of any preceding clause, further including regulating at least one of a quantity or a release duration of the fire extinguishing agent exiting the fire extinguishing nozzle during deployment of the fire extinguishing agent from the thermal transport bus.

The method of any preceding clause, further including identifying an additional thermal transport bus in connection with one or more fire extinguishing nozzles and initiating fire extinguishing agent release from the one or more fire extinguishing nozzles in response to the temperature sensor continuing to output temperature readings indicative of a fire.

The method of any preceding clause, wherein the fire extinguishing nozzle is positioned upstream or downstream of a supercritical carbon dioxide pump.

The method of any preceding clause, wherein the thermal transport bus in connection with a fire extinguishing nozzle is located in at least one of a cargo area or an engine area of the aircraft.

A non-transitory computer readable storage medium comprising instructions that, when executed, cause a processor to at least obtain a temperature sensor reading from a temperature sensor positioned on a thermal transport bus, the thermal transport bus in connection with a fire extinguishing nozzle, compare the temperature sensor reading to a set temperature range indicative of a fire, and deploy, in response to the temperature sensor reading at or above the set temperature range, fire extinguishing agent from the fire extinguishing nozzle, the fire extinguishing nozzle positioned to deploy the fire extinguishing agent to a location of an aircraft.

The non-transitory computer readable storage medium of any preceding clause, wherein the fire extinguishing agent is supercritical carbon dioxide.

The non-transitory computer readable storage medium of any preceding clause, wherein the thermal transport bus is in connection with a supercritical carbon dioxide pump and a heat source.

The non-transitory computer readable storage medium of any preceding clause, wherein the instructions, when executed, cause a processor to locate an additional thermal transport bus with a fire extinguisher to increase an output of the fire extinguishing agent or increase an area of fire extinguishing agent dispersal.

The non-transitory computer readable storage medium of any preceding clause, wherein the instructions, when executed, cause a processor to regulate at least one of a quantity or a release duration of the fire extinguishing agent exiting the fire extinguishing nozzle during deployment of the fire extinguishing agent from the thermal transport bus.

The non-transitory computer readable storage medium of any preceding clause, wherein the instructions, when executed, cause a processor to identify an additional thermal transport bus in connection with one or more fire extinguishing nozzles and initiate fire extinguishing agent release from the one or more fire extinguishing nozzles in response to the temperature sensor continuing to output temperature readings indicative of a fire.

The non-transitory computer readable storage medium of any preceding clause, wherein the fire extinguishing nozzle is positioned upstream or downstream of a supercritical carbon dioxide pump.

The non-transitory computer readable storage medium of any preceding clause, wherein the thermal transport bus in connection with a fire extinguishing nozzle is located in at least one of a cargo area or an engine area of the aircraft.

An apparatus, comprising means for obtaining a temperature sensor reading to obtain a temperature sensor reading from a means for sensing positioned on a thermal transport bus, the thermal transport bus in connection with a fire extinguishing nozzle, and compare the temperature sensor reading to a set temperature range indicative of a fire, and means for deploying, in response to the temperature sensor reading at or above the set temperature range, fire extinguishing agent from the fire extinguishing nozzle, the fire extinguishing nozzle positioned to deploy the fire extinguishing agent to a location of an aircraft.

The apparatus of any preceding clause, wherein the fire extinguishing agent is supercritical carbon dioxide.

The apparatus of any preceding clause, wherein the thermal transport bus is in connection with a supercritical carbon dioxide pump and a heat source.

The apparatus of any preceding clause, further including means for locating an additional thermal transport bus with a fire extinguisher to increase an output of the fire extinguishing agent or increase an area of fire extinguishing agent dispersal.

The apparatus of any preceding clause, wherein the means for locating an additional thermal transport bus includes identifying an additional thermal transport bus in connection with one or more fire extinguishing nozzles and initiating fire extinguishing agent release from the one or more fire extinguishing nozzles in response to the temperature sensor continuing to output temperature readings indicative of a fire.

The apparatus of any preceding clause, wherein the means for deploying include regulating at least one of a quantity or a release duration of the fire extinguishing agent exiting the fire extinguishing nozzle during deployment of the fire extinguishing agent from the thermal transport bus.

The apparatus of any preceding clause, wherein the fire extinguishing nozzle is positioned upstream or downstream of a supercritical carbon dioxide pump.

The apparatus of any preceding clause, wherein the thermal transport bus in connection with a fire extinguishing nozzle is located in at least one of a cargo area or an engine area of the aircraft.

What is claimed is:

1. A fire extinguishing system, comprising:
a thermal transport bus to transfer heat between fluids on an aircraft using a working fluid; and
a fire extinguishing nozzle connected to the thermal transport bus, the fire extinguishing nozzle positioned to deploy the working fluid as a fire extinguishing agent to a location of the aircraft.

2. The fire extinguishing system of claim 1, wherein the fire extinguishing agent is supercritical carbon dioxide.

3. The fire extinguishing system of claim 1, wherein the thermal transport bus is in connection with at least one of a supercritical carbon dioxide pump or a heat source.

4. The fire extinguishing system of claim 3, wherein the heat source includes at least one of bleed air, a bypass stream, or exhaust heat.

5. The fire extinguishing system of claim 1, wherein the fire extinguishing nozzle is positioned at least one of (1) upstream or downstream of a split valve, or (2) upstream or downstream of a heat source.

6. The fire extinguishing system of claim 1, wherein the thermal transport bus is in connection with a first flow split valve and a second flow split valve, a first fire extinguishing nozzle positioned upstream or downstream of the first flow split valve and a second fire extinguishing nozzle positioned upstream or downstream of the second flow split valve.

7. An apparatus comprising:
memory;
instructions; and
processor circuitry to execute the instructions to:
obtain a temperature sensor reading from a temperature sensor positioned on a thermal transport bus, the thermal transport bus in connection with a fire extinguishing nozzle;
compare the temperature sensor reading to a set temperature range indicative of a fire; and
deploy, in response to the temperature sensor reading at or above the set temperature range, fire extinguishing agent from the fire extinguishing nozzle, the fire extinguishing nozzle positioned to deploy the fire extinguishing agent to a location of an aircraft.

8. The apparatus of claim 7, wherein the fire extinguishing agent is supercritical carbon dioxide.

9. The apparatus of claim 7, wherein the thermal transport bus is in connection with a supercritical carbon dioxide pump and a heat source.

10. The apparatus of claim 7, wherein the processor circuitry is to locate an additional thermal transport bus with a fire extinguisher to increase an output of the fire extinguishing agent or increase an area of fire extinguishing agent dispersal.

11. The apparatus of claim 7, wherein the processor circuitry is to regulate at least one of a quantity or a release duration of the fire extinguishing agent exiting the fire extinguishing nozzle during deployment of the fire extinguishing agent from the thermal transport bus.

12. The apparatus of claim 7, wherein the processor circuitry is to identify an additional thermal transport bus in connection with one or more fire extinguishing nozzles, the processor circuitry to initiate fire extinguishing agent release from the one or more fire extinguishing nozzles in response to the temperature sensor continuing to output temperature readings indicative of a fire.

13. The apparatus of claim 7, wherein the fire extinguishing nozzle is positioned upstream or downstream of a supercritical carbon dioxide pump.

14. A method, comprising:
obtaining a temperature sensor reading from a temperature sensor positioned on a thermal transport bus, the thermal transport bus in connection with a fire extinguishing nozzle;
comparing the temperature sensor reading to a set temperature range indicative of a fire; and
deploying, in response to the temperature sensor reading at or above the set temperature range, fire extinguishing agent from the fire extinguishing nozzle, the fire extinguishing nozzle positioned to deploy the fire extinguishing agent to a location of an aircraft.

15. The method of claim 14, wherein the fire extinguishing agent is supercritical carbon dioxide.

16. The method of claim 14, wherein the thermal transport bus is in connection with a supercritical carbon dioxide pump and a heat source.

17. The method of claim 14, further including locating an additional thermal transport bus with a fire extinguisher to increase an output of the fire extinguishing agent or increase an area of fire extinguishing agent dispersal.

18. The method of claim 14, further including regulating at least one of a quantity or a release duration of the fire extinguishing agent exiting the fire extinguishing nozzle during deployment of the fire extinguishing agent from the thermal transport bus.

19. The method of claim 14, further including identifying an additional thermal transport bus in connection with one or more fire extinguishing nozzles and initiating fire extinguishing agent release from the one or more fire extinguishing nozzles in response to the temperature sensor continuing to output temperature readings indicative of a fire.

20. The method of claim 14, wherein the fire extinguishing nozzle is positioned upstream or downstream of a supercritical carbon dioxide pump.
